(19) United States
(12) Patent Application Publication
(10) Pub. No.: US 2021/0285521 A1
(43) Pub. Date: Sep. 16, 2021

(54) STAR GEAR TORQUER

(71) Applicant: GANG LIU, ZHENGZHOU (CN)

(72) Inventor: GANG LIU, ZHENGZHOU (CN)

(21) Appl. No.: 17/258,729

(22) PCT Filed: Sep. 5, 2019
(86) PCT No.: PCT/CN2019/095575

§ 371 Date: Mar. 7, 2021

(30) Foreign Application Priority Data
Jul. 11, 2018 (CN) 201810832558.4
Jul. 11, 2018 (CN) 201821183360.X
Apr. 3, 2019 (CN) 201910297698.0
Apr. 3, 2019 (CN) 201920501342.X

(51) Int. Cl. F16H 1/46; F16H 37/04; F16H 37/02; F16H 57/02; H02K 7/116; H02K 7/18

(52) U.S. Cl. CPC F16H 1/46; F16H 37/04; F16H 37/02; F16H 57/02; B62M 11/02; H02K 7/1823; F16H 2057/02034; F16H 2057/02043; H02K 7/116

(57) ABSTRACT

The present invention provides a star gear torquer, including a base seat, a casing, a first end cover, a second end cover and a transmission system. The transmission system includes: a transmission component; an input shaft that is in sliding connection with the first end cover; an output shaft that is in sliding connection with the second end cover; a sun gear that is fixed to the input shaft; a rotary plate that is in sliding connection with the first end cover; a gear shaft that is in sliding connection with the rotary plate; a first planet gear that is engages with the sun gear; a second planet gear that is engages with a ring gear; the ring gear that is fixed on the casing; and a driven plate that is provided between the first planet gear and the second planet gear.

### TECHNICAL FIELD

The present invention relates to the field of mechanical transmission devices, particularly to a star gear torquer.

### BACKGROUND ART

As is known, there are various mechanical transmission methods. In practical applications, transmission methods such as gear transmission, hydraulic transmission and magnetic transmission are commonly used. Among them, gear transmission has the advantages of smooth transmission, high transmission efficiency, and being suitable for various application scenarios. Therefore, gear transmission is more and more widely applied. As a type of gear transmission, a planet gear mechanism is also widely used.

However, in the related art, although the planetary gear mechanism has the characteristics of high transmission stability, an internal transmission structure thereof is relatively complicated and greater friction occurs between gears, resulting in large energy loss and restricting improvement of the transmission efficiency.

Therefore, it is necessary to provide a new star gear torquer to solve the above technical problems.

### SUMMARY OF INVENTION

An object of the present invention is to provide a star gear torquer having low energy loss and high transmission efficiency.

To achieve the object, the present invention provides a star gear torquer, including: a base seat; a casing supported by the base seat; a first end cover and a second end cover that are fixed to both opposite ends of the casing respectively; and a transmission system that is supported by the first end cover and the second end cover. The casing, the first end cover and the second end cover define an accommodating space. Each of the first end cover and the second end cover is provided with a bearing. The transmission system is partially accommodated in the accommodating space, and both opposite portions thereof are supported by the first end cover and the second end cover respectively via the bearing. The transmission system includes a first transmission component, a second transmission component, an input shaft, an output shaft, a sun gear, a rotary plate, a gear shaft, a first planet gear, a second planet gear, a driven plate, and a ring gear.

The first transmission component is disposed outside the accommodating space and is spaced apart from an outer surface of the first end cover, and is configured to input motive power.

The second transmission component is disposed outside the accommodating space and is spaced apart from an outer surface of the second end cover, and is configured to output motive power.

The input shaft is in sliding connection with the first end cover through the bearing of the first end cover. A part of the input shaft is located outside the accommodating space and is fixed to the first transmission component, and the other part thereof is accommodated in the accommodating space.

The output shaft is in sliding connection with the second end cover through the bearing of the second end cover. A part of the output shaft is located outside the accommodating space and is fixed to the second transmission component, and the other part thereof is accommodated in the accommodating space. An end of the output shaft, which is away from the second transmission component, is in sliding connection with an end of the input shaft, which is away from the first transmission component.

The sun gear is accommodated in the accommodating space and is fixed to the input shaft.

The rotary plate is disposed between the first end cover and the sun gear, and is provided with a central bearing hole, a positioning slot and a rotary plate bearing hole all of which penetrate the rotary plate. The rotary plate is in sliding connection with a bearing seat of the bearing of the first end cover through the central bearing hole. At least two positioning slots are provided and the at least two positioning slots are evenly distributed at peripheral positions of the rotary plate, and each positioning slot has a semi-circular shape or a polygonal shape. In addition, at least two rotary plate bearing holes are provided and each rotary plate bearing hole is provided between the central bearing hole and the positioning slot.

One end of the gear shaft, which is adjacent to the first end cover, is in sliding connection with the rotary plate through the rotary plate bearing hole.

The first planet gear is fixed at one side of the gear shaft, which is adjacent to the rotary plate, and is spaced apart from the rotary plate. The first planet gear engages with the sun gear.

The second planet gear is fixed at one side of the gear shaft, which is away from the rotary plate, and is spaced apart from the first planet gear.

The driven plate is provided between the first planet gear and the second planet gear, and is provided with a central shaft hole, a positioning column and a driven plate bearing hole. The driven plate is fixed with the output shaft through the central shaft hole, and is in sliding connection with the gear shaft through an internal bearing provided in the driven plate bearing hole. At least two positioning columns are provided and each positioning column is inserted into a corresponding positioning slot. A shape of the positioning column matches with a shape of the positioning slot. The positioning column is provided with a through hole therein for setting a fixing bolt. With the fixing bolt, the rotary plate and the driven plate are fixedly connected to form an integrated structure. In addition, at least two driven plate bearing holes are provided, and each driven plate bearing hole is provided between the central shaft hole and the positioning column.

The ring gear is accommodated in the accommodating space and is fixed on the casing. The ring gear engages with the second planet gear to provide rotation support for the second planet gear.

Here, the sliding connection refers to sliding contact between components realized by provision of a bearing at a sliding connection position.

Preferably, the first transmission component is any one of a gear, a belt pulley and a flange, and similarly the second transmission component is any one of a gear, a belt pulley and a flange.

Preferably, the sun gear, the first planet gear and the second planet gear are external gears; the ring gear is an internal gear.

Preferably, a distance from the first planet gear to the second planet gear is larger than a distance from the first planet gear to the rotary plate.

Preferably, the input shaft is in sliding connection with the output shaft via a thrust bearing.

The present invention also provides a power system that includes both a power unit for inputting motive power and the star gear torquer of the present invention. The power unit is coupled with the first transmission component to form a power mechanism. The power unit is configured to drive the first transmission component to rotate so as to realize input of motive power to the star gear torquer via the first transmission component. The power unit may be either of an internal combustion engine and an electric motor.

The present invention also provides a transportation vehicle that includes a wheel assembly and the power system of the present invention. The wheel assembly is coupled with the second transmission component, and the power system drives the wheel assembly to rotate via the second transmission component.

The present invention also provides a ship that includes a propeller blade and the power system of the present invention. The propeller blade is coupled with the second transmission component, and the power system drives the propeller blade to rotate via the second transmission component.

The present invention also provides a helicopter that includes a rotor blade and the power system of the present invention. The rotor blade is coupled with the second transmission component, and the power system drives the rotor blade to rotate via the second transmission component.

The present invention also provides a generator set that includes a blade, a generator and the star gear torquer of the present invention. The blade is coupled with the first transmission component, and the generator is coupled with the second transmission component.

As compared with the related art, the star gear torquer of the present invention has an optimized structure of an internal transmission system, in which the first planet gear and the second planet gear are fixed to both ends of the gear shaft respectively; the driven plate is provided between the first planet gear and the second planet gear; the first planet gear is forced by the sun gear; the ring gear is supported by the second planet gear; the gear shaft forms a lever with a force bearing point formed at where the driven plate is in sliding connection with the gear shaft; the gear shaft is forced by the first planet gear and supports the driven plate; and the driven plate is fixedly connected to the output shaft and transmits motive power to the output shaft. With such a structure, efficiency of gear train transmission is improved, greatly reducing energy loss during transmission, and the transmission efficiency of the star gear torquer of the present invention is improved.

### BRIEF DESCRIPTION OF DRAWINGS

In order to describe the technical solutions in the embodiments of the present invention more clearly, the accompanying drawings needed in the description of the embodiments will be briefly described below. Obviously, the accompanying drawings in the following description only illustrate some embodiments of the present invention. For those skilled in the art, without creative work, other drawings can be obtained based on these drawings, among which:

FIG. 1 is a schematic structural diagram of a star gear torquer of the present invention;

FIG. 2 is a schematic structural diagram of a combination of the star gear torquer of the present invention and an internal combustion engine;

FIG. 3 is a schematic structural diagram of a combination of the star gear torquer of the present invention and an electric motor;

FIG. 4 is a schematic structural diagram of a combination of the star gear torquer of the present invention and a four-wheeled vehicle;

FIG. 5 is a schematic structural diagram of a combination of the star gear torquer of the present invention and a two-wheeled vehicle;

FIG. 6 is a schematic structural diagram of a combination of the star gear torquer of the present invention and a ship;

FIG. 7 is a schematic structural diagram of a combination of the star gear torquer of the present invention and a helicopter; and

FIG. 8 is a schematic structural diagram of a combination of the star gear torquer of the present invention and a generator set.

### DESCRIPTION OF EMBODIMENTS

Technical solutions in the embodiments of the present invention will be clearly and completely described below with reference to the accompanying drawings in the embodiments of the present invention. It is needless to say that the described embodiments are only a part of the embodiments of the present invention, rather than all the embodiments. All other embodiments based on the embodiments of the present invention and obtained by those skilled in the art without creative work shall fall within the protection scope of the present invention.

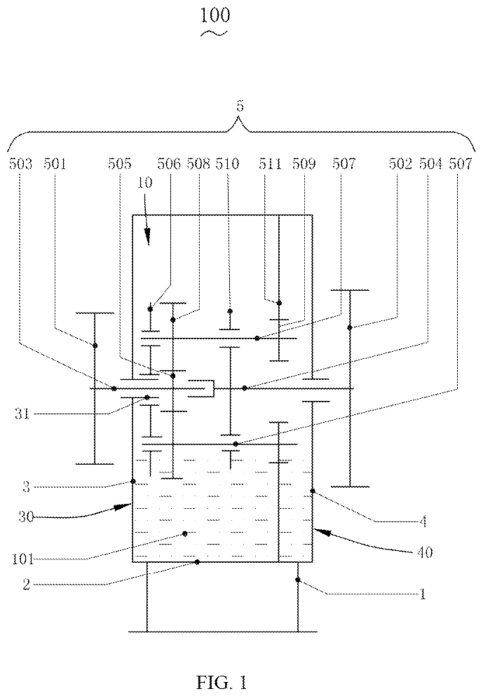

As illustrated in FIG. 1, the present invention provides a star gear torquer 100, including a base seat 1, a casing 2, a first end cover 3, a second end cover 4 and a transmission system 5.

The casing 2 is supported by the base seat 1. The casing 2 and the base seat 1 may be formed as an integrated structure or may be formed as separate structures. For example, in the present embodiment, the casing 2 and the base seat 1 are formed as an integrated structure, which efficiently improves integrity thereof. With such an integrated structure, fixing of the star gear torquer 100 in actual application is made reliable, thereby providing a reliable condition for transmission of the transmission system 5.

The first end cover 3 and the second end cover 4 are fixed to both opposite ends of the casing 2 respectively. The casing 2, the first end cover 3 and the second end cover 4 define an accommodating space 10. The first end cover 3 is provided with a bearing (not shown) and the second end cover 4 is provided with a bearing (not shown).

In the present embodiment, the transmission system 5 is supported by the first end cover 3 and the second end cover 4. Specifically, the transmission system 5 is partially accommodated in the accommodating space 10, and both opposite portions thereof are supported by the first end cover 3 and the second cover 4 respectively via the bearing.

Further, the transmission system 5 includes a first transmission component 501, a second transmission component 502, an input shaft 503, an output shaft 504, a sun gear 505, a rotary plate 506, a gear shaft 507, a first planet gear 508, a second planet gear 509, a driven plate 510, and a ring gear 511.

The first transmission component 501 is disposed outside the accommodating space 10 and is spaced apart from an outer surface 30 of the first end cover 3. The first transmission component 501 serves as a motive power input end of the star gear torquer 100 to input motive power, that is, the first transmission component 501 rotates under the action of an external force to realize the input of motive power.

The second transmission component 502 is disposed outside the accommodating space 10 and is spaced apart from an outer surface 40 of the second end cover 4. The second transmission component 502 serves as a motive power output end of the star gear torquer 100 to output the motive power. That is, the external force is input to the transmission system 5 via the first transmission component 501, transmitted through internal transmission of the transmission system 5, and output by the second transmission component 502 as the motive power.

The input shaft 503 is in sliding connection with the first end cover 3 through the bearing of the first end cover 3. A part of the input shaft 503 is located outside the accommodating space 10 and is fixed to the first transmission component 501, and the other part thereof is accommodated in the accommodating space 10. The first transmission component 501 is rotated to drive the input shaft 503 to rotate.

The output shaft 504 is in sliding connection with the second end cover 4 through the bearing of the second end cover 4. A part of the output shaft 504 is located outside the accommodating space 10 and is fixed to the second transmission component 502, and the other part thereof is accommodated in the accommodating space 10. An end of the output shaft 504, which is away from the second transmission component 502, is in sliding connection with an end of the input shaft 503, which is away from the first transmission component 501. Under the action of the motive power subjected to gear train transmission of the transmission system 5, the output shaft 504 rotates to drive the second transmission component 502 to rotate.

The sun gear 505 is accommodated in the accommodating space 10 and is fixed to the input shaft 503.

The rotary plate 506 is disposed between the first end cover 3 and the sun gear 505, and is provided with a central bearing hole (not shown), a positioning slot (not shown) and a rotary plate bearing hole (not shown) all of which penetrate the rotary plate 506. The rotary plate 506 is provided with an internal bearing (not shown) in the central bearing hole so as to be in sliding connection with a bearing seat 31 of the bearing of the first end cover 3.

It is worth mentioning that at least two positioning slots are provided and the at least two positioning slots are evenly distributed at peripheral positions of the rotary plate, and each positioning slot has a semi-circular shape or a polygonal shape. In addition, at least two rotary plate bearing holes are provided and each rotary plate bearing hole is provided between the central bearing hole and the positioning slot.

As an alternative embodiment, two positioning slots are provided, and each positioning slot has a semi-circular shape. It is needless to say that the number and shape of the positioning slots are not limited, and may be specifically set according to actual conditions of use. As an alternative embodiment, two rotary plate bearing holes are provided. It is needless to say that the number of the rotary plate bearing holes is not limited, and may be specifically set according to actual conditions of use.

One end of the gear shaft 507, which is adjacent to the first end cover 3, is in sliding connection with the rotary plate 506 through an internal bearing (not shown) provided in the rotary plate bearing hole. The gear shaft 507 rotates to drive the rotary plate 506 to rotate.

The planet gear 508 is fixed at one side of the gear shaft 507 which is adjacent to the rotary plate 506, and is spaced apart from the rotary plate 506. The first planet gear 508 engages with the sun gear 505, and as a planet gear of the sun gear 505, revolves around a central axis of the sun gear 505 with rotation of the sun gear 505.

The planet gear 509 is fixed at one side of the gear shaft 507 which is away from the rotary plate 506, and is spaced apart from the first planet gear 508. The gear shaft 507 drives the second planet gear 509 to rotate.

The driven plate 510 is disposed between the first planet gear 508 and the second planet gear 509, and is provided with a central shaft hole (not shown), a positioning column (not shown) and a driven plate bearing hole (not shown). The driven plate 510 is fixed with the output shaft 504 through the central shaft hole, and is in sliding connection with the gear shaft 507 through the driven plate bearing hole. The gear shaft 507 drives the driven plate 10 and the rotary plate 506 to rotate synchronously.

Note that at least two positioning columns are provided and the at least two positioning columns are inserted into the positioning slots correspondingly. In addition, at least two driven plate bearing holes are provided, and each driven plate bearing hole is provided between the central shaft hole and the positioning column. Since the positioning column is a positioning structure corresponding to the positioning slot, a shape of the positioning column corresponds to that of the positioning slot, and the number of the positioning columns corresponds to that of the positioning slots. As an alternative embodiment, two positioning columns are provided, and the two positioning columns are inserted into the positioning slots to realize positioning of the rotary plate 506 and the driven plate 510. In addition, the number of the driven plate bearing holes corresponds to that of the rotary plate bearing holes, and each driven plate bearing hole is provided to face each rotary plate bearing hole. The driven plate bearing hole and the rotary plate bearing hole provide rotation support for the gear shaft 507 via bearings respectively.

Preferably, in order to improve rotation reliability of the rotary plate 506 and the driven plate 510, the positioning column is provided with a through hole therein used for setting a fixing bolt. With the fixing bolt, the rotary plate 506 and the driven plate 510 are fixedly connected so as to form an integrated structure. Accordingly, reliability of synchronous rotation of the rotary plate 506 and the driven plate 510 is efficiently improved and the transmission is made smooth and reliable, thereby improving transmission effects.

The ring gear 511 is accommodated in the accommodating space and is fixed on the casing. The ring gear 511 engages with the second planet gear to provide rotation support for the second planet gear.

Here, it should be pointed out that the sliding connection refers to sliding contact between components realized by provision of a bearing at a sliding connection position.

It is worth mentioning that, in order to ensure transmission reliability of the transmission system 5, a lubricating oil 101 is provided in the accommodating space 10. A part of the transmission system 5 in the accommodating space 10 is immersed in the lubricating oil 101. With the lubricating oil 101, lubrication can be provided for a gear transmission structure of the transmission system 5. Accordingly, friction of the gear transmission structure during transmission is reduced, and the transmission of the transmission system 5 is effectively stabilized. Further energy loss is reduced and higher transmission efficiency is achieved.

More preferably, the first transmission component 501 is any one of a gear, a belt pulley and a flange, and similarly the second transmission component 502 is any one of a gear, a belt pulley and a flange. A specific selection may be made according to actual conditions of use.

More preferably, the sun gear 505, the first planet gear 508 and the second planet gear 509 are external gears, which are gear strictures with teeth on an outer side; the ring gear is an internal gear, which is a gear structure with teeth on an inner side. In the present embodiment, a gear module of the sun gear 505 is the same as that of the first planet gear 508, and a gear module of the second planet gear 509 is the same as that of the ring gear 51.

More preferably, a distance from the first planet gear to the second planet gear is larger than a distance from the first planet gear to the rotary plate.

More preferably, the input shaft 503 is in sliding connection with the output shaft 504 via a thrust bearing.

In the optimized structure of an internal transmission system of the star gear torquer 100, the first planet gear 508 and the second planet gear 509 are fixed to both ends of the gear shaft 507 respectively; the driven plate 510 is provided between the first planet gear and the second planet gear 509; the gear shaft 507 forms a lever with a force bearing point formed at where the driven plate 510 is in sliding connection with the gear shaft 507; the gear shaft 507 is forced by the first planet gear 508, supports the driven plate 510 and drives the driven plate 510 to rotate; and the driven plate 510 is fixedly connected to the output shaft 504 and transmits motive power to the output shaft 504. With such a structure, efficiency of gear train transmission is improved, greatly reducing energy loss during transmission, and the transmission efficiency of the star gear torquer 100 is improved.

Since having the above advantages, the star gear torquer 100 can be applied to different application scenarios, which will be described in a number of specific embodiments below.

### First Embodiment

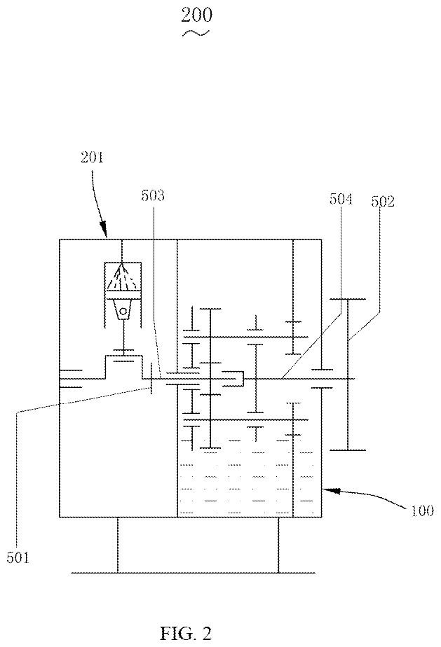

Now referring to FIG. 2, the present invention also provides a power system 200, which includes a power unit 201 for providing input motive power and the star gear torquer 100 of the present invention.

In the first embodiment, the power unit 201 is coupled with the first transmission component 501 to form a power mechanism. The power unit 201 is configured to drive the first transmission component 501 to rotate so as to realize input of motive power to the star gear torquer 100 via the first transmission component 501.

Further, the power unit 201 includes but is not limited to any one of an internal combustion engine and an electric motor. In the first embodiment, the power unit 201 is selected as an internal combustion engine.

Furthermore, in the present embodiment, the first transmission component 501 is a flange, and an output end of the power unit 201 is coupled with the first transmission component 501 via the flange. The power unit 201 operates to drive, via the flange, the first transmission component 501 to rotate, thereby driving the input shaft 503 to rotate. Accordingly, the star gear torquer 100 is made to operate, and the motive power is output by the second transmission component 502. In this way, a power system is formed.

### Second Embodiment

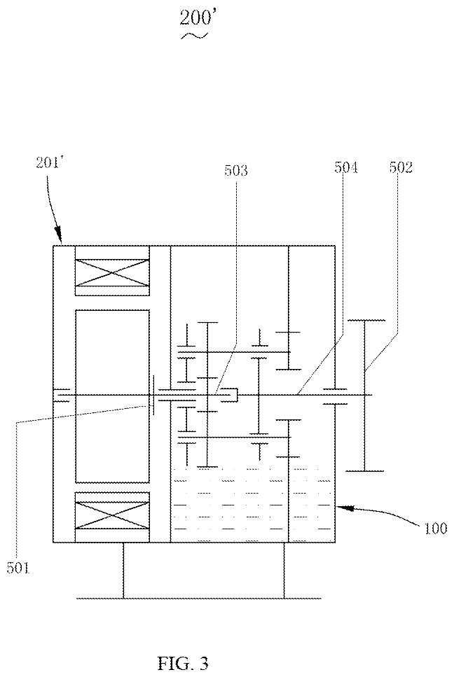

Now referring to FIG. 3, the present invention also provides a power system 200′. Since the specific structure, transmission principle and coupling mode of the power system 200′ are basically the same as those of the power system 200, a detailed description thereof will be omitted here. A difference therebetween is that a power unit 20 of the power system 200′ is an electric motor.

In the second embodiment, the first transmission component 501 is a flange, and an output end of the power unit 201′ is coupled with the first transmission component 501 via the flange. The power unit 201′ operates to drive, via the flange, the first transmission component 501 to rotate, thereby driving the input shaft 503 to rotate. Accordingly, the star gear torquer 100 is made to operate, and the motive power is output by the second transmission component 502. In this way, a power system is formed.

### Third Embodiment

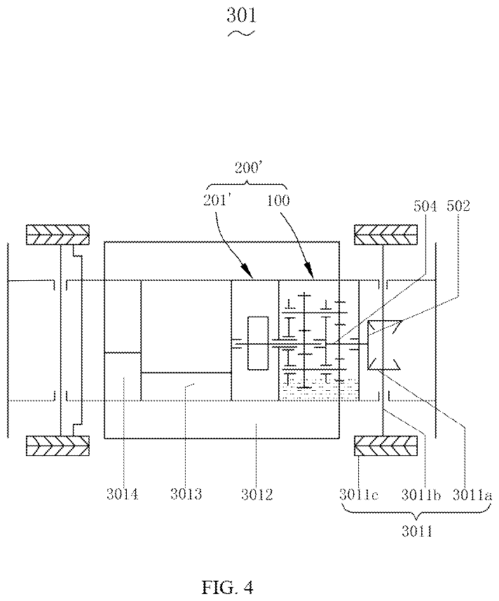

Now referring to FIGS. 3 and 4, the present invention also provides a transportation vehicle. The transportation vehicle is a four-wheeled vehicle 301. The four-wheeled vehicle 301 includes a wheel assembly 3011 and the power system 200′ of the second embodiment.

The wheel assembly 3011 is coupled with the second transmission component 502. Under drive of the power system 200′, the second transmission component 502 drives the wheel assembly 3011 to rotate.

In the third embodiment, the four-wheeled vehicle 301 further includes a vehicle frame 3012, and a battery pack 3013 and a controller 3014 that are installed on the vehicle frame 3012. The wheel assembly 3011 is also installed on the vehicle frame 3012. The wheel assembly 3011 includes a transmission gear 3011a, a transmission shaft 3011b and a wheel 3011c that are coupled in sequence.

The power system 200′ is fixed on the vehicle frame 3012. The second transmission component 502 is a gear, and the second transmission component 502 engages with the transmission gear 3011a.

In actual operation, the battery pack 3013 supplies electricity to the power unit 201′ when the controller 3014 receives an instruction, and the power unit 201′ operates to drive the star gear torquer 100 to operate. Then the second transmission component 502 is rotated to drive the transmission gear 3011a to rotate, and the transmission gear 3011a drives the transmission shaft 3011b and the wheel 3011c to rotate, thereby generating forward motive force.

### Fourth Embodiment

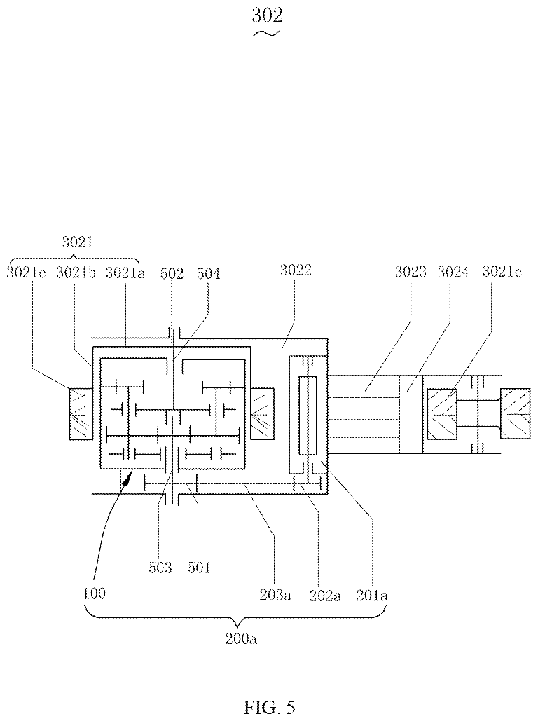

Now referring to FIGS. 3 and 5, the present invention also provides a transportation vehicle that is a two-wheeled electric vehicle 302. The two-wheeled electric vehicle 302 includes a wheel assembly 3021 and a power system 200a. The power system 200a includes a power unit 201a for providing input motive power and the star gear torquer 100 of the present invention. The power unit 201a is an electric motor. The first transmission component 501 of the star gear torquer 100 is a gear.

In the fourth embodiment, the power system 200a further includes: a transmission gear 202a fixed to the power unit 201a; and a transmission chain 203a that engages with the first transmission component 501 and the transmission gear 202a.

The power unit 201a operates to drive the transmission gear 202a to rotate, and further drives the first transmission component 501 via the transmission chain 203a so that motive power is input to the star gear torquer 100 via the first transmission component 501. The wheel assembly 3021 is coupled with the second transmission component 502, and the power system 200a drives the wheel assembly 3021 to rotate via the second transmission component 502.

Further, the two-wheeled electric vehicle 302 also includes a vehicle frame 3022, and a battery pack 3023 and a controller 3024 that are installed on the vehicle frame 3022. The wheel assembly 3021 is also installed on the vehicle frame 3022. The wheel assembly 3021 includes a wheel carrier 3021a, a wheel disk 3021b and a wheel 3021c that are coupled in sequence. The wheel carrier 3021a and the wheel disk 3021b are an integrated structure.

The power system 200a is fixed on the vehicle frame 3022. The second transmission component 502 is a gear, and is fixedly connected with the wheel carrier 3021a. An outer end portion of the output shaft 504 is supported on the vehicle frame 3022 through a bearing.

In actual operation, the battery pack 3023 supplies electricity to the power unit 201a when the controller 3024 receives an instruction, and the power unit 201a operates. The power unit 201a drives the transmission gear 202a to rotate, and further drives the first transmission component 501 to rotate via the transmission chain 203a so that the star gear torquer 100 operates. Further the second transmission component 502 is rotated to drive the wheel carrier 3021a to rotate, and the wheel carrier 3021a drives the wheel disk 3021b and the wheel 3021c to rotate together, thereby generating forward motive power.

### Fifth Embodiment

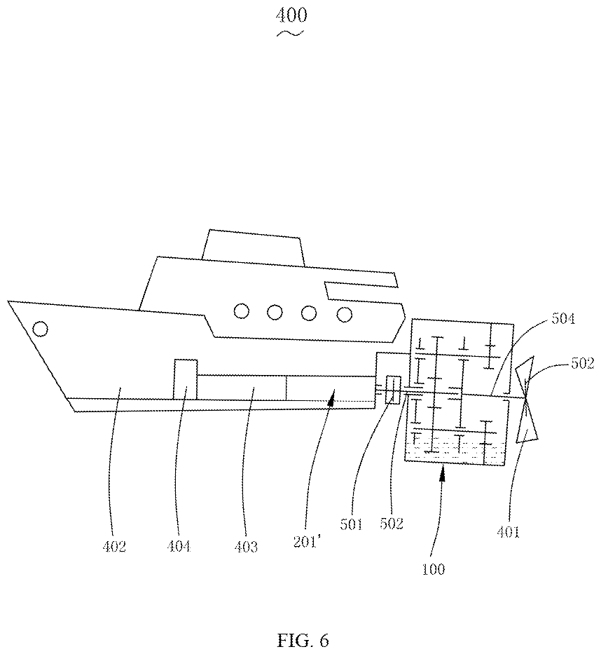

Now referring to FIGS. 3 and 6, the present invention also provides a ship 400, which includes a propeller blade 401 and the power system 200′ of the second embodiment.

The propeller blade 401 is coupled with the second transmission component 502. The power system 200′ drives the propeller blade 401 to rotate via the second transmission component 502. Alternatively, the propeller blade 401 may be coupled with the output shaft 504 directly, which may be set according to actual conditions, and this coupling mode does not affect the implementation of the embodiment.

In the fifth embodiment, the ship 400 also includes a ship body 402, and a battery pack 403 and a controller 404 that are installed on the ship body 402. The power system 200′ is installed on the ship body 402, and the electric motor of the power system 200′ is in electrical connection with the battery pack 403.

In actual operation, the propeller blade 401 is placed in water. The battery pack 403 supplies electricity to the power unit 201′ when the controller 404 receives an instruction, and the power unit 201′ operates. The power unit 201′ drives the star gear torquer 100 to operate, and further the second transmission component 502 is rotated to drive the propeller blade 401 to rotate, thereby generating propelling thrust in water.

### Sixth Embodiment

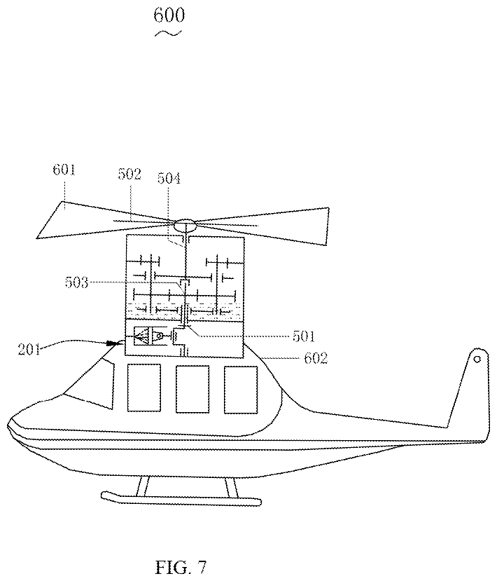

Now referring to FIGS. 2 and 7, the present invention also provides a helicopter 600, which includes a rotor blade 601 and the power system 200 of the first embodiment.

The rotor blade 601 is coupled with the second transmission component 502. The power system 200 drives the rotor blade 601 to rotate via the second transmission component 502. Alternatively, the rotor blade 601 may be coupled with the output shaft 504 directly, which may be set according to actual conditions, and this coupling mode does not affect the implementation of the embodiment.

In the sixth embodiment, the helicopter 600 also includes a helicopter body 602, and the power system 200 is installed on the helicopter body 602.

In actual operation, the power unit 201 (that is an internal combustion engine) operates to drive the star gear torquer 100 to operate so that the second transmission component 502 is rotated to drive the rotor blade 601 to rotate, thereby generating a lift force.

### Seventh Embodiment

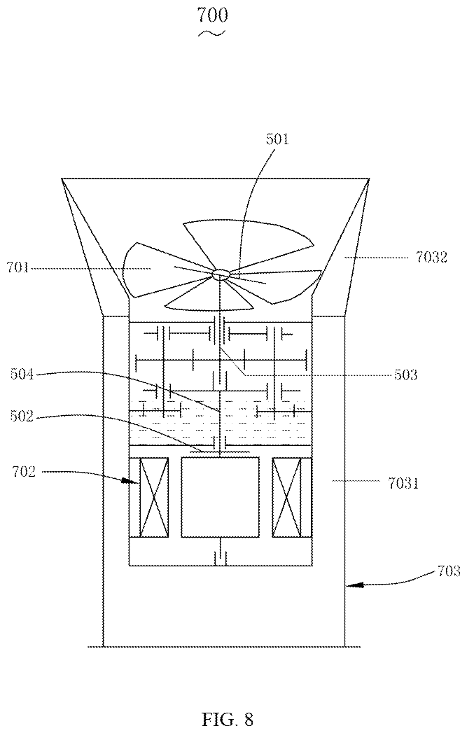

Now referring to FIGS. 1 and 8, the present invention also provides a generator set 700 that includes a blade 701, a generator 702 and the star gear torquer 100 of the present invention.

The blade 701 is coupled with the first transmission component 501, and the generator 702 is coupled with the second transmission component 502.

In the seventh embodiment, the generator set 700 further includes a water flow pipe 703. The water flow pipe is provided with a flow pipe 7031 and a flow neck 7032 fixedly connected to the flow pipe 7031. The blade 701 is arranged in the flow neck 7032.

In actual operation, the flow pipe is disposed on a ground base. When a water flow passes through the flow neck 7032, the water flow pushes the blade 701 to rotate, thereby driving the first transmission component 501 to rotate. Then the star gear torquer 100 is driven to operate and causes the second transmission component 502 to rotate, thereby driving a generator rotor of the generator 701 to rotate. The generator rotor converts mechanical energy into electrical energy under the action of magnetic field induction.

As compared with the related art, the star gear torquer of the present invention has an optimized structure of an internal transmission system, in which the first planet gear and the second planet gear are fixed to both ends of the gear shaft respectively; the driven plate is provided between the first planet gear and the second planet gear; the first planet gear is forced by the sun gear; the ring gear is supported by the second planet gear; the gear shaft forms a lever with a force bearing point formed at where the driven plate is in sliding connection with the gear shaft; the gear shaft is forced by the first planet gear and supports the driven plate; and the driven plate is fixedly connected to the output shaft and transmits motive power to the output shaft. With such a structure, efficiency of gear train transmission is improved, greatly reducing energy loss during transmission, and the transmission efficiency of the star gear torquer is improved.

The above is only the implementation method of the invention. It should be pointed out that, for ordinary technicians in the field, improvements can be made without breaking away from the creative idea of the invention, but these are within the protection scope of the invention.

1. A star gear torquer, comprising:
a base seat;
a casing supported by the base seat;
a first end cover and a second end cover that are fixed to both opposite ends of the casing respectively;
and a transmission system that is supported by the first end cover and the second end cover;
the casing, the first end cover and the second end cover define an accommodating space;
each of the first end cover and the second end cover is provided with a bearing;
the transmission system is partially accommodated in the accommodating space, and both opposite portions thereof are supported by the first end cover and the second end cover respectively via the bearing;
wherein the transmission system including:
the first transmission component is disposed outside the accommodating space and is spaced apart from an outer surface of the first end cover, and is configured to input motive power;
the second transmission component is disposed outside the accommodating space and is spaced apart from an outer surface of the second end cover, and is configured to output motive power;
the input shaft is in sliding connection with the first end cover through the bearing of the first end cover, a part of the input shaft is located outside the accommodating space and is fixed to the first transmission component, and the other part thereof is accommodated in the accommodating space;
the output shaft is in sliding connection with the second end cover through the bearing of the second end cover, a part of the output shaft is located outside the accommodating space and is fixed to the second transmission component, and the other part thereof is accommodated in the accommodating space, an end of the output shaft, which is away from the second transmission component, is in sliding connection with an end of the input shaft, which is away from the first transmission component;
the sun gear is accommodated in the accommodating space and is fixed to the input shaft;
the rotary plate is disposed between the first end cover and the sun gear, and is provided with a central bearing hole, a positioning slot and a rotary plate bearing hole all of which penetrate the rotary plate, the rotary plate is in sliding connection with a bearing seat of the bearing of the first end cover through the central bearing hole, at least two positioning slots are provided and the at least two positioning slots are evenly distributed at peripheral positions of the rotary plate, and each positioning slot has a semi-circular shape or a polygonal shape, in addition, at least two rotary plate bearing holes are provided and each rotary plate bearing hole is provided between the central bearing hole and the positioning slot;
one end of the gear shaft, which is adjacent to the first end cover, is in sliding connection with the rotary plate through the rotary plate bearing hole;
the first planet gear is fixed at one side of the gear shaft, which is adjacent to the rotary plate, and is spaced apart from the rotary plate, the first planet gear engages with the sun gear;
the second planet gear is fixed at one side of the gear shaft, which is away from the rotary plate, and is spaced apart from the first planet gear;
the driven plate is provided between the first planet gear and the second planet gear, and is provided with a central shaft hole, a positioning column and a driven plate bearing hole, the driven plate is fixed with the output shaft through the central shaft hole, and is in sliding connection with the gear shaft through an internal bearing provided in the driven plate bearing hole. at least two positioning columns are provided and each positioning column is inserted into a corresponding positioning slot, a shape of the positioning column matches with a shape of the positioning slot, the positioning column is provided with a through hole therein for setting a fixing bolt, with the fixing bolt, the rotary plate and the driven plate are fixedly connected to form an integrated structure, in addition, at least two driven plate bearing holes are provided, and each driven plate bearing hole is provided between the central shaft hole and the positioning column;
the ring gear is accommodated in the accommodating space and is fixed on the casing, the ring gear engages with the second planet gear to provide rotation support for the second planet gear;
here, the sliding connection refers to sliding contact between components realized by provision of a bearing at a sliding connection position.

2. The star gear torquer according to claim 1, wherein the first transmission component is any one of a gear, a belt pulley and a flange, and similarly the second transmission component is any one of a gear, a belt pulley and a flange.

3. The star gear torquer according to claim 1, wherein the sun gear, the first planet gear and the second planet gear are external gears; the ring gear is an internal gear.

4. The star gear torquer according to claim 1, wherein a distance from the first planet gear to the second planet gear is larger than a distance from the first planet gear to the rotary plate.

5. The star gear torquer according to claim 1, wherein the input shaft is in sliding connection with the output shaft via a thrust bearing.

6. A power system, comprising:
a power unit for providing input motive power; and
the star gear torquer according to any of claim 1;
wherein the power unit is coupled with the first transmission component to form a power mechanism, the power unit is configured to drive the first transmission component to rotate so as to realize input of motive power to the star gear torquer via the first transmission component, the power unit may be either of an internal combustion engine and an electric motor.

7-9. (canceled)

10. A generator set, comprising:
a blade;
a generator; and
the star gear torquer according to any of claim 1;
wherein the blade is coupled with the first transmission component, and the generator is coupled with the second transmission component.
